(19) United States
(12) Patent Application Publication
(10) Pub. No.: US 2013/0231930 A1
(43) Pub. Date: Sep. 5, 2013

(54) METHOD AND APPARATUS FOR AUTOMATICALLY FILTERING AN AUDIO SIGNAL

(71) Applicant: Antonio Sanso, Allschwil (CH)

(72) Inventor: Antonio Sanso, Allschwil (CH)

(73) Assignee: Adobe Systems Inc., San Jose, CA (US)

(21) Appl. No.: 13/409,871

(22) Filed: Mar. 1, 2012

(51) Int. Cl. G10L 15/26; G10L 21/00

(52) U.S. Cl. 704/235; 704/270; 704/E15.043; 704/E21.001

(57) ABSTRACT

A computer implemented method and apparatus for automatically filtering an audio input to make a filtered recording comprising: identifying words used in an audio input, determining whether each identified word is contained in a dictionary of banned words, and creating a filtered recording as an audio output, wherein each word identified in the audio input that is found in the dictionary of banned words, is automatically deleted or replaced in the audio output used to make the filtered recording.

### BACKGROUND OF THE INVENTION

1. Field of the Invention

The present invention generally relates to filtering audio signals and, more particularly, to a method and apparatus for automatically filtering an audio signal to be recorded.

2. Description of the Related Art

Online communication plays a critical role in training, presentations, and conferencing. Web-based conferencing tools such as ADOBE® CONNECT™ (as provided by Adobe Systems, Inc. of San Jose, Calif.) facilitate online communication between web participants, and provide a feature for recording an online communication. However, as people become more comfortable communicating online, undesirable content may slip into the conversation, or confidential information, such as brand names or other proprietary matter may be discussed. Audio filtering is used to remove such content from the recording. There are many scenarios in which audio filtering is needed, for example, in telephonic conferencing, Voice over Internet Protocol (VoIP) conferencing, video conferencing, and the like, where multiple participants are being recorded.

Currently, methods of audio filtering involve post-conference editing. Audio editing software requires playback of the audio recording and any content that is undesirable must be removed manually. Whether editing a recorded full-day meeting or a one-hour conference call, the manpower spent reviewing the recording is both timely and costly.

Therefore, there is a need for a method and apparatus for automatically filtering an audio signal.

### SUMMARY OF THE INVENTION

Embodiments of the present invention generally relate to a method and apparatus for automatically filtering an audio signal when making a recording of the audio signal. The method comprises identifying words in an audio input. The method then determines whether each identified word is contained in a dictionary of banned words. A filtered recording is created as an audio output wherein each word identified in the audio input that is found in the dictionary of banned words, is automatically deleted or replaced in an audio output used to make the filtered recording.

### BRIEF DESCRIPTION OF THE DRAWINGS

FIG. 1 depicts a block diagram of an apparatus for filtering an audio signal, according to one or more embodiments;

FIG. 2 depicts a block diagram of a web-based conferencing system for automatically filtering an audio signal utilizing the apparatus of FIG. 1, according to one or more embodiments;

FIG. 3 depicts a flow diagram of a method of filtering audio input as performed by the audio filter module of FIG. 2, according to one or more embodiments; and

FIG. 4 depicts a computer system that can be utilized to implement the method of FIG. 3, according to one or more embodiments.

While the method and apparatus is described herein by way of example for several embodiments and illustrative drawings, those skilled in the art will recognize that the method and apparatus for automatically filtering an audio signal is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the method and apparatus for automatically filtering an audio signal as defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

Embodiments of the present invention comprise a method and apparatus for automatically filtering an audio input signal for making a filtered audio recording. In one embodiment, when the audio input signal is received, it is converted to text words using an audio-to-text conversion software so as to identify words used in the audio input signal. Then, each identified word is compared to a dictionary of banned words. If the identified word is not found in the dictionary of banned words, the identified word is converted back to audio using a text-to-audio synthesizer and placed in a filtered audio output signal for making a filtered audio recording. If the identified word is found in the dictionary, the word is not placed in the filtered audio output signal and is instead replaced with a tone or other audio indicia which indicates that a word was replaced in the filtered audio recording. The dictionary of banned words may be updated before an audio input signal is received.

In another embodiment, when the audio input signal is received, instead of performing audio-to-text conversion of the audio input signal, an audio signature comparison is performed between each word uttered in the audio input signal and the audio signature of the words in the dictionary of banned words. If the audio signature of an uttered word matches the audio signature of a word in the dictionary, the uttered word is replaced in the audio signal output with a tone or other audio indicia which indicates that a word was replaced.

In an alternate embodiment, a start time and a stop time may be noted for each banned word identified in the audio input signal, using, for example, the audio signature comparison technique, and then the audio input signal can be recorded. Thereafter, the recording can be automatically edited by deleting the audio between those start and stop times or replacing the audio between those start and stop times with a tone or other audio indicia which indicates that a word was replaced.

Various embodiments of a method and apparatus for automatically filtering an audio signal are described. In the following detailed description, numerous specific details are set forth to provide a thorough understanding of the claimed subject matter. However, it will be understood by those skilled in the art that the claimed subject matter may be practiced without these specific details. In other instances, methods, apparatuses or systems that would be known by one of ordinary skill have not been described in detail so as not to obscure the claimed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

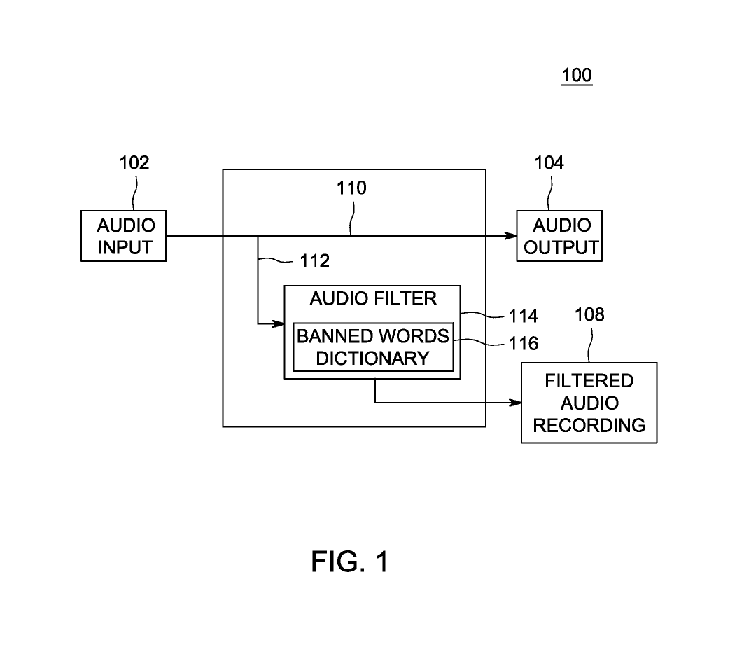

FIG. 1 depicts a block diagram of an apparatus for automatically filtering an audio signal, according to one or more embodiments.

The apparatus 100 separates the audio input 102 into two streams; a first audio stream 110 for an audio output 104 and a second audio stream 112 for generating a filtered audio recording 108. The second audio stream 112 is provided as input into the audio filter 114. The audio filter 114 converts the second audio stream to text words using an audio-to-text conversion software, and then compares each text word against a dictionary of banned words 116. Words found in the dictionary 116 are removed and replaced in the filtered audio signal with a tone or other audio indicia to indicate that a word was removed. Words not found in the dictionary 116 are converted back to audio and placed in the filtered audio signal used for generating the filtered audio recording 108. In an alternative embodiment (not specifically shown), the first audio stream 110 may be delayed before reaching the audio output 104, so that when banned words are identified by audio filter 114, they may be deleted or replaced in the audio stream 110 before reaching audio output 104.

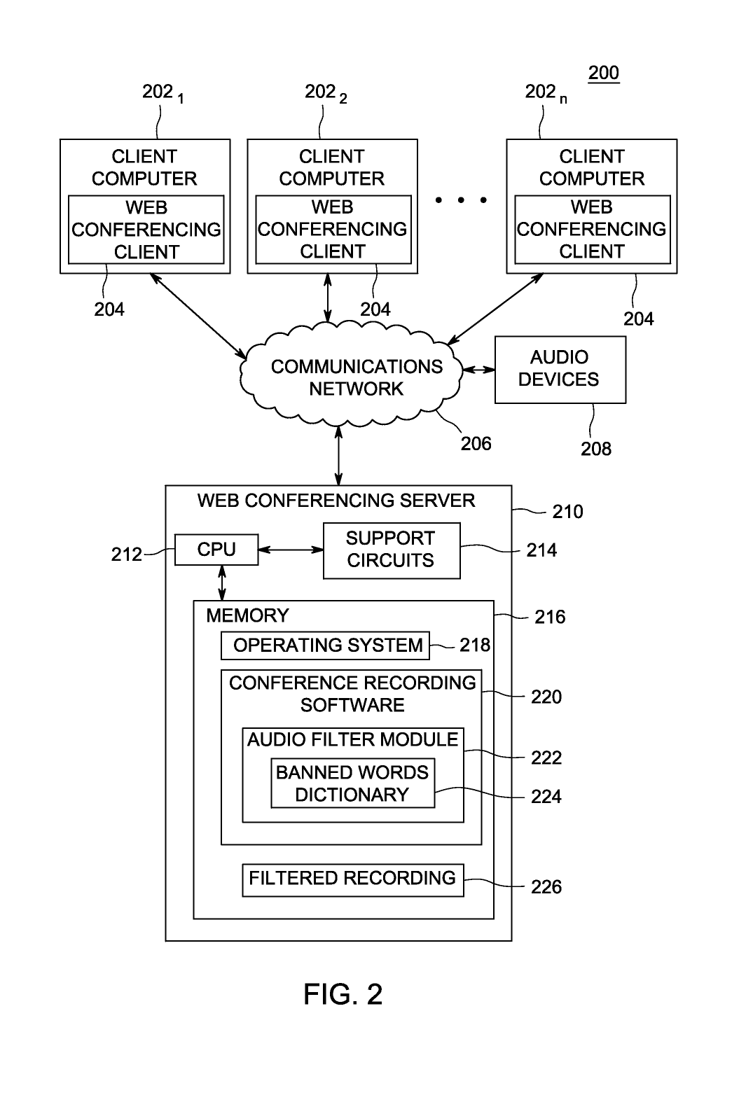

FIG. 2 depicts a block diagram of a web-based conferencing system 200 using conference recording software 220 for automatically filtering an audio signal and/or content, according to one or more embodiments of the invention. For example, ADOBE® CONNECT™ provides web-based conferencing to facilitate multiuser collaboration via chat rooms, audio discussions, presentations, webinars, and the like. In one embodiment, the system 200 comprises a plurality of client computers 202₁, 202₂ . . . 202ₙ connected to one another and to a web conferencing server via a communications network 206. Each client computer 202 comprises a web conferencing client 204 (e.g., software executing on the client computer to facilitate web-based conferencing). Each client computer 202 participating in a web-based conference forms an audio input 102.

The communications network 206 may be any digital network or combination of networks that supports web-based (Internet) communications including, but not limited to, local and/or wide area networks, wireless networks, optical fiber networks, cable networks, and the like.

The web conferencing server 210 comprises a Central Processing Unit (or CPU) 212, support circuits 214, and a memory 216. The CPU 212 may comprise one or more commercially available microprocessors or microcontrollers that facilitate data processing and storage. The various support circuits 214 facilitate the operation of the CPU 212 and include one or more clock circuits, power supplies, cache, input/output circuits, and the like. The memory 216 comprises at least one of Read Only Memory (ROM), Random Access Memory (RAM), disk drive storage, optical storage, removable storage and/or the like.

The memory 216 further comprises conference recording software 220, a filtered recording 226, and an Operating System 218. The operating system 218 may comprise various commercially known operating systems.

The conference recording software 220 comprises an audio filter module 222. The audio filter module 222 comprises a banned words dictionary 224. The banned word dictionary 224 contains a list of words that will be filtered from the audio input 102. These may be any words deemed offensive, or simply words that are proprietary or confidential that a company would not want listeners of a recorded conference to hear. In some embodiments, the words in the dictionary 224 are in multiple languages. The dictionary 224 may be updated before the start of a recording or during a recording session in order to include proprietary or confidential words that may be discussed. In some embodiments, the dictionary 224 is updated via a user interface.

In further embodiments, the dictionary 224 may be organized such that each word is subject to a number of filtering rules and each rule includes a list of words. In this embodiment, the dictionary 224 may store the filtering rules. Alternatively, the filtering rules may be stored in the audio filter module 222 in a file separate from the dictionary 224. The user may indicate which filtering rule should be active for the received recording.

In this embodiment, the audio filter module 222 is used to filter audio signals and/or content (the two words are interchangeably used hereinafter) from client computers 202 coupled to the web conferencing server 210 (e.g., a FLASH® media gateway supporting ADOBE® CONNECT™). The audio filter module 222 receives the combined audio signals received from various participants (e.g., client computers 202) as a single audio input 102. In one embodiment, the filtered recording 226 is stored on the web conferencing server 210. In another embodiment, the filtered recording 226 is streamed or broadcast to its destination.

Furthermore, the combined audio signal may be distributed by the web conferencing server 210 through call routing to a Public Switched Telephone Network (PSTN) and/or a Session Initiation Protocol (SIP) network. As such, endpoints of the network may comprise mixed technology users represented as audio devices 208 including, conventional telephone handset, cellular telephone, video conference equipment, devices with a FLASH® client, and so on. FLASH®, ADOBE®, and ADOBE® CONNECT™ are registered trademarks of Adobe Systems Incorporated.

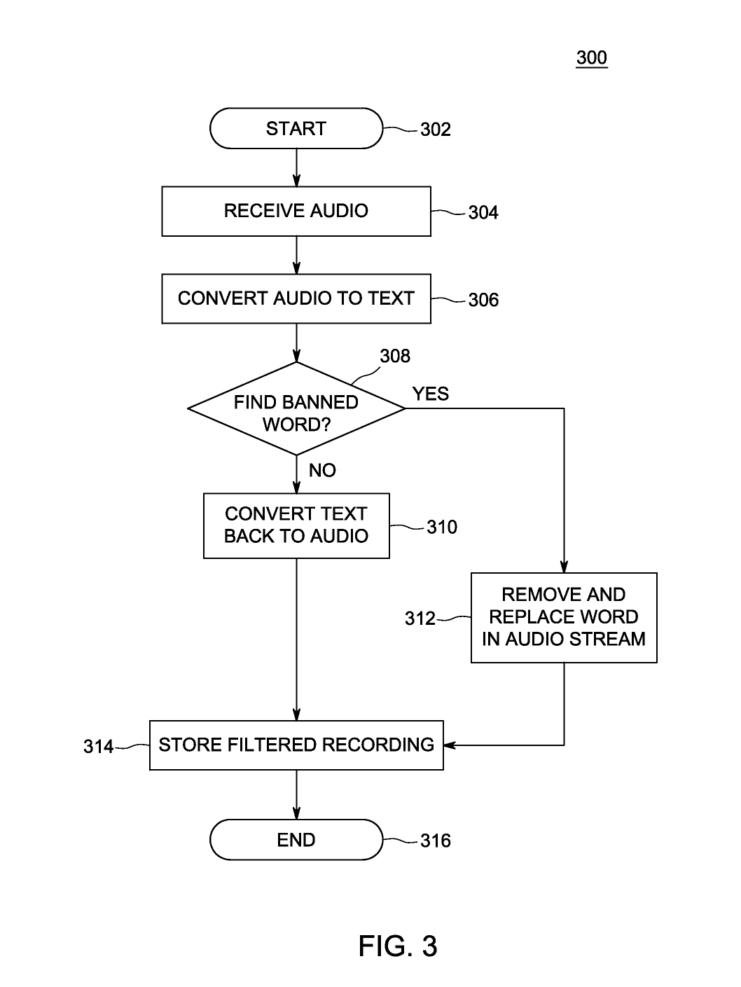

FIG. 3 is a method 300 for filtering audio input as performed by the audio filter module 222 of FIG. 2. In one embodiment described below, the method converts the audio signal input to text utilizing audio-to-text conversion software and then extracts the words from the audio input. The audio-to-text conversion software can be implemented using known speech recognition techniques that can tolerate various accents and/or pronunciations and speech variations. Each extracted word is compared to the words in a dictionary of banned words. If the extracted word is not found in the dictionary, the extracted word is converted back to audio. In some embodiments the original audio portion for the extracted word is used. If the extracted word is found in the dictionary, it is removed or replaced in the filtered recording. In another embodiment (not specifically shown), instead of performing audio-to-text conversion, the method 300 determines the audio signature of each word uttered in the audio input and then compares those audio signatures with an audio signature of each of the words in the dictionary. This can be realized using currently available pattern recognition techniques known to those of ordinary skill in the art. If the audio signatures match, the word is removed or replaced in an audio output signal used to make a filtered recording. The method ends with storing the filtered recording. Techniques for performing audio signature identification of words are well known to those of ordinary skill in the art, and used, for example in the fore noted audio-to-text conversion (speech recognition) software.

The method 300 starts at step 302, and proceeds to step 304. At step 304, the method 300 receives an audio input. In one embodiment, the audio input is received from a web conference. The audio input is split into two streams, a first stream for audio output, and a second stream for audio recording. The method 300 performs filtering on the second stream. The method 300 proceeds to step 306. At step 306, the method 300 uses an audio-to-text conversion software to convert each word uttered in the audio input into text. In one embodiment, the method 300 uses the Java Script audio speech API, however, it will be understood by those skilled in the art the various methods for audio-to-text conversion. The method 300 proceeds to step 308.

At step 308, the method 300 determines whether the text word is a banned word. The method 300 compares the text word to a dictionary of banned words. The dictionary of banned words contains any vocabulary that may be deemed rude, offensive, proprietary, or confidential. Before the method 300 receives the audio input, the dictionary may be updated in order to add or remove words, in accordance with a user's requirements. If the text word is not found in the dictionary, the method 300 proceeds to step 310. At step 310, the method 300 converts the text word back to audio. Those skilled in the art will recognize the various methods that can be used for converting text to audio. Alternatively, the method 300 simply uses the original audio word without converting the text word back to audio. The method 300 proceeds to step 314. If at step 308, the text word is found in the dictionary, the method 300 proceeds to step 312. At step 312, the method 300 removes the text word and replaces it in the audio filtered recording. In one embodiment, the word may be replaced by a beep in the filtered recording. The method 300 proceeds to step 314.

At step 314, the method 300 stores the filtered recording in memory. Alternatively, the method 300 streams or broadcasts the filtered recording. The method 300 proceeds to step 316 and ends.

As noted above, in another embodiment (not specifically shown), instead of performing audio-to-text conversion, the method 300 determines the audio signature of each word uttered in the audio input signal and then compares those audio signatures with an audio signature of each of the words in the dictionary. Those of ordinary skill in the art will appreciate the various known pattern recognition techniques which can be used to perform the audio signature matches. If the audio signatures match, the word is removed or replaced in an audio output signal used to make a filtered recording. If the audio signatures do not match, the word is not removed or replace in the audio input.

The present invention may be embodied as methods, apparatus, electronic devices, and/or computer program products. Accordingly, the present invention may be embodied in hardware and/or in software (including firmware, resident software, micro-code, etc.), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium include the following: hard disks, optical storage devices, a transmission media such as those supporting the Internet or an intranet, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. For example, in FIG. 1, the audio input to audio filter 114 may be split into first and second signal paths, and the time relationship between the two paths are tracked. In the first signal path, the method and apparatus performs the extraction and comparison after audio-to-text conversion of the audio input as previously described. However, in the second signal path the audio input remains in analog form. That is, it is not converted to text using an audio-to-text conversion. When a banned word is found using the first signal path, a portion of the second signal that corresponds in time to where the banned word is uttered, is replaced with a synthesized word or audio replacement, and the remainder of the second signal retains all of the original audio. Thus, the filtered audio output for recording, in this alternative embodiment, retains the original audio for all of the audio recording, except for those time portions where any banned words are found. The illustrated embodiments were chosen and described in order to best explain the principles of the present disclosure and its practical applications, to thereby enable others skilled in the art to best utilize the invention and various embodiments with various modifications as may be suited to the particular use contemplated.

### Example Computer System

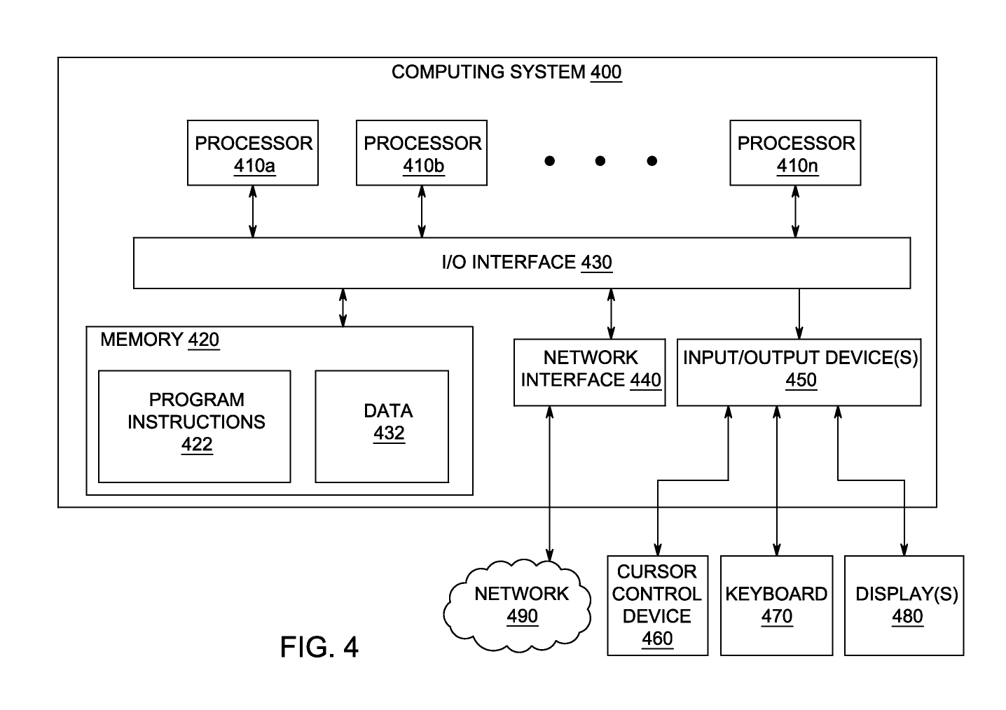

FIG. 4 depicts a computer system that can be utilized in various embodiments of the present invention, according to one or more embodiments.

Various embodiments of an apparatus and method for automatically filtering an audio recording, as described herein, may be executed on one or more computer systems, which may interact with various other devices. One such computer system is computer system 400 illustrated by FIG. 4, which may in various embodiments implement any of the elements or functionality illustrated in FIGS. 1-3. In various embodiments, computer system 400 may be configured to implement methods described above. The computer system 400 may be used to implement any other system, device, element, functionality or method of the above-described embodiments. In the illustrated embodiments, computer system 400 may be configured to implement method 300, as processor-executable executable program instructions 422 (e.g., program instructions executable by processor(s) 410a-n) in various embodiments.

In the illustrated embodiment, computer system 400 includes one or more processors 410a-n coupled to a system memory 420 via an input/output (I/O) interface 430. The computer system 400 further includes a network interface 440 coupled to I/O interface 430, and one or more input/output devices 450, such as cursor control device 460, keyboard 470, and display(s) 480. In various embodiments, any of components may be utilized by the system to receive user input described above. In various embodiments, a user interface (e.g., user interface) may be generated and displayed on display 480. In some cases, it is contemplated that embodiments may be implemented using a single instance of computer system 400, while in other embodiments multiple such systems, or multiple nodes making up computer system 400, may be configured to host different portions or instances of various embodiments. For example, in one embodiment some elements may be implemented via one or more nodes of computer system 400 that are distinct from those nodes implementing other elements. In another example, multiple nodes may implement computer system 400 in a distributed manner.

In different embodiments, computer system 400 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 400 may be a uniprocessor system including one processor 410, or a multiprocessor system including several processors 410 (e.g., two, four, eight, or another suitable number). Processors 410a-n may be any suitable processor capable of executing instructions. For example, in various embodiments processors 410 may be general-purpose or embedded processors implementing any of a variety of instruction set architectures (ISAs), such as the x96, PowerPC, SPARC, or MIPS ISAs, or any other suitable ISA. In multiprocessor systems, each of processors 410a-n may commonly, but not necessarily, implement the same ISA.

System memory 420 may be configured to store program instructions 422 and/or data 432 accessible by processor 410. In various embodiments, system memory 420 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 420. In other embodiments, program instructions and/or data may be received, sent or stored upon different types of computer-accessible media or on similar media separate from system memory 420 or computer system 400.

In one embodiment, I/O interface 430 may be configured to coordinate I/O traffic between processor 410, system memory 420, and any peripheral devices in the device, including network interface 440 or other peripheral interfaces, such as input/output devices 450. In some embodiments, I/O interface 430 may perform any necessary protocol, timing or other data transformations to convert data signals from one components (e.g., system memory 420) into a format suitable for use by another component (e.g., processor 410). In some embodiments, I/O interface 430 may include support for devices attached through various types of peripheral buses, such as a variant of the Peripheral Component Interconnect (PCI) bus standard or the Universal Serial Bus (USB) standard, for example. In some embodiments, the function of I/O interface 430 may be split into two or more separate components, such as a north bridge and a south bridge, for example. Also, in some embodiments some or all of the functionality of I/O interface 430, such as an interface to system memory 420, may be incorporated directly into processor 410.

Network interface 440 may be configured to allow data to be exchanged between computer system 400 and other devices attached to a network (e.g., network 490), such as one or more external systems or between nodes of computer system 400. In various embodiments, network 490 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 440 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 450 may, in some embodiments, include one or more display terminals, keyboards, keypads, touchpads, scanning devices, voice or optical recognition devices, or any other devices suitable for entering or accessing data by one or more computer systems 400. Multiple input/output devices 450 may be present in computer system 400 or may be distributed on various nodes of computer system 400. In some embodiments, similar input/output devices may be separate from computer system 400 and may interact with one or more nodes of computer system 400 through a wired or wireless connection, such as over network interface 440.

In some embodiments, the illustrated computer system may implement any of the methods described above, such as the methods illustrated by the flowchart of FIG. 3. In other embodiments, different elements and data may be included.

Those skilled in the art will appreciate that computer system 400 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, etc. Computer system 400 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 400 may be transmitted to computer system 400 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, etc.), ROM, etc.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A computer implemented method of automatically filtering an audio input to make a filtered recording comprising:
identifying words used in an audio input;
determining whether each identified word is contained in a dictionary of banned words; and
creating a filtered recording as an audio output, wherein each word identified in the audio input that is found in the dictionary of banned words, is automatically deleted or replaced in the audio output used to make the filtered recording.

2. The method of claim 1, wherein the audio input is a combination of audio signals from a conference call, wherein each audio signal represents a voice of a participant in the conference call.

3. The method of claim 1, wherein the audio input is split into a first stream for an audio output and a second stream for making the filtered recording.

4. The method of claim 1, wherein identifying words used in the audio input comprises performing audio-to-text conversion.

5. The method of claim 1, wherein creating includes converting each word not found in the dictionary of banned word back to audio in the filtered recording.

6. The method of claim 1, wherein identifying words used in the audio input comprises determining the audio signature of each word uttered in the audio input, and wherein determining compares those audio signatures with an audio signature of each of the words in the dictionary.

7. The method of claim 6, wherein creating includes recording a start time and a stop time for each banned word identified in the audio input and then automatically editing the audio input by one of deleting audio between the recorded start and stop times or replacing the audio between those start and stop times with an audio indicia which indicates that a word was replaced.

8. A computer-readable storage medium comprising one or more processor executable instructions that, when executed by at least one processor, causes the at least one processor to perform a method of automatically filtering an audio input to make a filtered recording comprising:
identifying words used in an audio input;
determining whether each identified word is contained in a dictionary of banned words; and
creating a filtered recording as an audio output, wherein each word identified in the audio input that is found in the dictionary of banned words, is automatically deleted or replaced in the audio output used to make the filtered recording.

9. The computer readable medium of claim 8, wherein the audio input is a combination of audio signals from a conference call, wherein each audio signal represents a voice of a participant in the conference call.

10. The computer readable medium of claim 8, wherein the audio input is split into a first stream for an audio output and a second stream for making the filtered audio recording.

11. The computer readable medium of claim 8, wherein identifying words used in the audio input comprises performing audio-to-text conversion.

12. The computer readable medium of claim 8, wherein creating includes converting each word not found in the dictionary of banned word back to audio in the filtered recording.

13. The computer readable medium of claim 8, wherein identifying words used in the audio input comprises determining the audio signature of each word uttered in the audio input, and wherein determining compares those audio signatures with an audio signature of each of the words in the dictionary.

14. The computer readable medium of claim 13, wherein creating includes recording a start time and a stop time for each banned word identified in the audio input and then automatically editing the audio input by one of deleting audio between the recorded start and stop times or replacing the audio between those start and stop times with an audio indicia which indicates that a word was replaced.

15. An apparatus for supporting filtering an audio input to make a filtered recording comprising:
a web conferencing server, coupled through a communications network to the plurality of client computers comprising and audio filter for receiving as an audio input the combined audio signals generated by the plurality of web conferencing clients that are participating in a conference, the audio filter
extracting text from the audio input;
determining whether each word of the text is contained in a dictionary of banned words; and
creating a filtered recording as an audio output, wherein each word extracted from the audio input that is found in the dictionary of banned words, is automatically deleted or replaced in the filtered recording and each word not found in the dictionary of banned words is converted back to audio in the filtered recording.

16. The apparatus of claim 15, wherein the audio input is a combination of audio signals from a conference call, wherein each audio signal represents a voice of a participant in the conference call.

17. The apparatus of claim 15, wherein the audio input is split into a first stream for audio output and a second stream for making the filtered audio recording.

18. The apparatus of claim 15, wherein identifying words used in the audio input comprises performing audio-to-text conversion.

19. The apparatus of claim 15, wherein identifying words used in the audio input comprises determining the audio signature of each word uttered in the audio input, and wherein determining compares those audio signatures with an audio signature of each of the words in the dictionary.

20. The apparatus of claim 19, wherein creating includes recording a start time and a stop time for each banned word identified in the audio input and then automatically editing the audio input by one of deleting audio between the recorded start and stop times or replacing the audio between those start and stop times with an audio indicia which indicates that a word was replaced.
